(19) United States
(12) Patent Application Publication
(10) Pub. No.: US 2025/0035544 A1
(43) Pub. Date: Jan. 30, 2025

(54) GAS ANALYSIS DEVICE, GAS ANALYSIS METHOD, AND PROGRAM FOR GAS ANALYSIS DEVICE

(71) Applicant: HORIBA, LTD., Kyoto-shi, Kyoto (JP)

(72) Inventors: Naoki NAGURA, Kyoto-shi, Kyoto (JP); Yasushi KAWABUCHI, Kyoto-shi, Kyoto (JP); Daichi TAKAHASHI, Kyoto-shi, Kyoto (JP); Kenji HARA, Kyoto-shi, Kyoto (JP); Takayuki KIKUTA, Kyoto-shi, Kyoto (JP); Masaya YOSHIOKA, Kyoto-shi, Kyoto (JP); Kotaro NAKAMURA, Kyoto-shi, Kyoto (JP)

(73) Assignee: HORIBA, LTD., Kyoto-shi, Kyoto (JP)

(21) Appl. No.: 18/696,835

(22) PCT Filed: Oct. 3, 2022
(86) PCT No.: PCT/JP2022/036925

§ 371 Date: Mar. 28, 2024

(30) Foreign Application Priority Data
Oct. 12, 2021 (JP) 2021-167740

(51) Int. Cl. G01N 21/3504; G01N 1/22; G01N 21/03; G01N 21/35; G01N 21/39

(52) U.S. Cl. CPC G01N 21/3504; G01N 1/2247; G01N 21/0332; G01N 2001/227; G01N 2021/3595; G01N 21/39; G01N 2201/12715

(57) ABSTRACT

A gas analysis device includes a sample cell into which sample gas is introduced, a light source that irradiates the sample cell with light, a photodetector that detects light intensity of light which passes through the sample cell irradiated by the light source, a concentration calculation unit which calculates a concentration of a measurement target component contained in the sample gas based on light intensity outputted from the photodetector, and a light intensity output unit that outputs, comparably with a reference light intensity set in advance, a light intensity at calibration detected by the photodetector during calibration.

### TECHNICAL FIELD

The present invention relates to a gas analysis device, a gas analysis method, and a program for a gas analysis device, for example for analyzing exhaust gas.

### BACKGROUND ART

In gas analysis devices that use absorption analysis methods such as FTIR (Fourier transform infrared spectroscopy) or QCL-IR (mid-infrared laser spectroscopy), a multiple reflection type sample cell with a plurality of mirrors is used (see Patent Literature 1) in order to increase the optical path length of the light passing through the measurement target gas. In such a gas analysis device, a sample cell is irradiated with light, the light intensity of light led out after multiple reflections in the sample cell is detected by a photodetector, and the concentration or the like of the measurement target component in the sample is measured based on the light intensity signal output from the photodetector.

When this type of gas analysis device is used, for example, to analyze exhaust gas or the like from automobiles, the mirrors of the sample cell become dirty due to contaminants such as hydrocarbons (HC) and particulate matter (PM) contained in the exhaust gas. If a mirror becomes contaminated in a gas analysis device using a multiple reflection type sample cell, the light intensity (signal intensity) detected by the photodetector decreases by the power of the number of multiple reflections. For example, if the sample cell reflects the incident light 100 times, even if the reflectance of the mirror only drops from 100% to 99%, the signal intensity detected by the photodetector will drop to 36.6%. In this manner, if the signal intensity detected by the photodetector decreases too much, it may result in increased noise due to poor fitting during calculation, inaccurate measurement values, and finally a state in which measurement is no longer possible. Similar problems may also occur if the light intensity of the light introduced into the measurement cell decreases due to deterioration of the light source.

In conventional gas analysis devices, the user is unable to verify the signal intensity detected by the photodetector, and thus cannot check the contamination status of the mirror, the deterioration status of the light source, and so on (hereinafter referred to as ‘mirror contamination status or the like’). Because of this, when using a gas analysis device, there was a risk of an increase in noise occurring without the user noticing, decreasing analysis accuracy. This type of problem is not limited only to the use of a multiple reflection type sample cell, but can occur in general in any gas analysis device using absorption analysis methods.

### PRIOR ART LITERATURE

### Patent Literature

Patent Literature 1: Japanese Patent Application Publication No. 2012-002799

### SUMMARY OF THE INVENTION

### Problem to be Solved by the Invention

The present invention was developed in view of the problems described above, and its main object is to improve the reliability of measured values by enabling the user to determine the mirror contamination status or the like in a gas analysis device that performs absorption analysis.

### Means of Solving the Problem

That is, a gas analysis device according to the present invention includes a sample cell into which sample gas is introduced; a light source that irradiates the sample cell with light; a photodetector that detects light intensity of light which passes through the sample cell irradiated by the light source; a concentration calculation unit which calculates a concentration of a measurement target component contained in the sample gas based on light intensity outputted from the photodetector; and a light intensity output unit that outputs, comparably with a reference light intensity set in advance, a light intensity at calibration detected by the photodetector during calibration.

According to such a configuration, the light intensity at calibration detected by the photodetector during calibration is output comparably with a reference light intensity set in advance. Therefore, the user can determine the mirror contamination status or the like by, when calibration of the analysis device is carried out, comparing the light intensity at calibration to the reference light intensity to verify it, increasing the reliability of the measured value.

As a specific configuration of the gas analysis device, one is given which further includes a calibration gas supply line that supplies a calibration gas to the sample cell, wherein the light intensity output unit outputs, as the light intensity at calibration, light intensity detected by the photodetector in a state in which the calibration gas is supplied to the sample cell.

Also, the gas analysis device is preferably one wherein the light intensity output unit outputs the light intensity at calibration as a relative value with respect to the reference light intensity.

According to this configuration, the light intensity at calibration output is not output as a raw signal, and instead a relative value with respected to the reference light intensity is output, so that it is possible to more easily know the state of contamination of the mirror or deterioration of the light source, etc.

It is preferable that the gas analysis device be one which further includes a warning output unit which compares the relative value with a predetermined threshold value set in advance, and outputs a warning signal if the relative value exceeds the threshold value.

Like this, by outputting a warning signal, the user is able to notice that a time to perform maintenance is approaching, or notice that maintenance must be performed immediately, such that it is possible to avoid a problem in which the gas analysis device suddenly becomes unusable.

It is preferable that the gas analysis device is one that analyzes a plurality of measurement target components contained in the sample gas, and one wherein the light intensity output unit outputs the light intensity at calibration for each wavelength region corresponding to each of the measurement target components.

As such, it is possible to better determine the mirror contamination status or the like via the user comparing the light intensity at calibration in each wavelength region. That is, if measurement is done in a plurality of wavelength regions, but light intensity at calibration of only a specific wavelength region is output to determine the mirror contamination status, since the light intensity at calibration in the other wavelength regions is not known, there is a danger that mirror contamination status or the like will not be able to be determined accurately. However, in the present embodiment, by outputting the light intensity at calibration for each wavelength region corresponding to the plurality of measurement target components and determining the mirror contamination status or the like, the mirror contamination status or the like is determined in greater detail.

As a specific configuration of the gas analysis device, one is given wherein the reference light intensity is light intensity detected by the photodetector during calibration performed at a time of product shipment or before initiation of a first measurement.

Also, the gas analysis device is preferably one wherein the light intensity output unit outputs, as the light intensity at calibration, light intensity detected by the photodetector during zero calibration.

With such a configuration, unlike when it comes to span calibration, the same type of calibration gas is always used during zero calibration, so that the conditions can be made to match up every time the light intensity at calibration is obtained. Therefore, it is possible to more accurately determine the progress of mirror contamination and the like.

A configuration which particularly exhibits the effect of the present invention is one wherein the sample cell is a multiple reflection type cell that emits incident light to an exterior after multiple reflections.

A specific example of the gas analysis device is one wherein the gas analysis device is an FTIR method or a QCL-IR method type one.

By the way, in order to reliably measure the concentration of the measurement target component in the exhaust gas, it is necessary to prevent solid and particulate matter such as soot contained in the exhaust gas from entering the sample cell. Therefore, conventionally, in the gas introduction line that introduces exhaust gas into the sample cell, a plurality of filters is installed before the flow restriction unit, which is a critical flow orifice or the like, to remove solid or particulate matter contained in the exhaust gas.

However, in a reduced pressure system gas analysis device such as this, the introduction of solid or particulate matter into the sample cell cannot be completely prevented even if filters are installed in the gas introduction line, and contamination within the sample cell (of the mirrors) progresses, influencing the gas concentration measurement and accuracy thereof. Because ammonia, a measurement target component in exhaust gas, is highly adsorptive, the number of filters could not be indiscriminately increased without causing a decrease in response time.

A DPF (diesel particulate filter) that removes PM from diesel engine exhaust gas undergoes a process called ‘DPF regeneration.’ in which fuel is periodically forcefully injected to raise the exhaust gas temperature and burn PM that is stuck inside the filter. As a result of the present inventors' diligent research, it was discovered that, during this DPF regeneration mode, high boiling point hydrocarbons that are not produced during normal operation are produced, and that these are likely a cause of mirror contamination. Furthermore, as for conventional sample cells, their temperature may be controlled by a heater or other temperature control mechanism embedded in the receptacle portion of the cell, but the mirrors inside the cell themselves are only heated by the internal atmosphere and are not temperature-controlled, making them cooler than the inner walls. Therefore, the mirrors end up being a cold spot which high boiling point hydrocarbons adsorb to, and the inventors discovered that this is highly likely to be related to mirror contamination.

Therefore, it is preferable that the gas analysis device be one further including a cell heating mechanism which heats the sample cell to a predetermined temperature; and a gas introduction line which introduces the collected sample gas into the sample cell, and is provided with a flow restriction unit which restricts a flow rate of the sample gas introduced into the sample cell; wherein a filter is provided in the gas introduction line on a downstream side of the flow restriction unit, for eliminating particulate matter contained within the sample gas.

Configured this way, since a filter mechanism is provided in the gas introduction line in the reduced pressure section on the downstream side of the flow restriction unit, it is possible to promote the growth of microscopic particles and collect them. Thanks to this, microscopic particles which were not able to be captured upstream of the flow restriction unit are captured, and it is possible to prevent the introduction of solid and particulate matter to the interior of the sample cell.

Also, it is preferable that the gas analysis device be one wherein the filter is maintained at a temperature higher than a dew point temperature of the sample gas passing therethrough, and lower than the predetermined temperature.

Like this, the filter provided in the reduced pressure section of the gas introduction line is made to be a cold spot with a temperature lower than that of the measurement cell, so it is possible to have the high boiling point hydrocarbons which are a cause of mirror contamination adsorb to the filter at a stage prior to being adsorbed within the sample cell.

The gas analysis device is moreover preferably one wherein an upstream side filter is further provided in the gas introduction line on an upstream side of the flow restriction unit, for eliminating particulate matter from within the sample gas.

Incidentally, in automobile emission standards, exhaust gas is regulated according to emitted mass values, and a dilution measurement method is most commonly used when these emission mass values are measured. In a dilution measurement method, exhaust gas which exits the exhaust pipe of a vehicle which is the test subject is introduced into a dilution tunnel using an introduction pipe, and concentration of the diluted exhaust gas is measured—or, after sampling from the dilution tunnel into a bag, concentration measurement of the inside of the bag is performed. Then, the emitted mass value is calculated. However, if a highly adsorptive component such as ammonia (NH₃) is contained in the exhaust gas being measured, when the exhaust gas is introduced into the dilution tunnel, the gas component ends up adsorbing to the pipe walls or the like along its route, and accurately calculating an emitted mass value becomes a problem.

Therefore, an exhaust gas analysis system according to the present invention is preferably one that analyzes a measurement target component contained in exhaust gas emitted from a test subject which is a vehicle or a part thereof, including: a main flow path connected to an exhaust pipe of the test subject, into which the exhaust gas is introduced; a flowmeter which measures a flow rate of the exhaust gas flowing in the main flow path; a sampling part which collects a portion of the exhaust gas from the main flow path upstream of the flowmeter; the aforementioned gas analysis device that analyzes the exhaust gas collected by the sampling part and measures a concentration of the measurement target component; and an emissions amount calculation unit which calculates an amount of emissions of the measurement target component based on a corrected flow rate, which is a flow rate measured by the flowmeter which has been corrected by a flow rate collected by the sampling part, and a concentration of the measurement target component measured by the gas analysis device.

With a configuration like this, rather than performing concentration measurement after the exhaust gas is introduced into a dilution flow path, sampling is done before introduction into a dilution flow path and concentration is measured; furthermore, sampling of the exhaust gas is done from an upstream side of the flowmeter. Therefore, accurate measurement of the concentration of a highly adsorptive measurement target component can be achieved in a state in which adsorption to an inner pipe wall is minimal. Furthermore, since the flow rate measured by the flowmeter is corrected by the flow rate of the sampled exhaust gas, even when sampling of the exhaust gas is done from upstream of the flowmeter, the influence of this on the flow rate value used to calculate the amount of emissions can be reduced. Thanks to this, the influence of adsorption onto the inner pipe wall of the measurement target component can be reduced, and it is possible to measure the amount of emissions thereof with high accuracy.

A configuration which particularly exhibits the effect of the exhaust gas analysis system is one wherein the measurement target component has high adsorptivity to an inner pipe wall which forms the main flow path, and includes a water-soluble component; particularly, wherein NH₃ is included.

The exhaust gas analysis system is preferably one further including a heating mechanism which heats a section of the main flow path between an exit of the exhaust pipe and a sample point of the sampling part.

Configured like this, gas adsorption to an inner pipe wall between the exit of the exhaust pipe and the sampling point is reduced, and calculation of the amount of emissions of the measurement target component can be done with higher accuracy.

The exhaust gas analysis system is preferably one wherein the exhaust gas flowing in the main flow path is raw exhaust gas which has not been diluted.

A gas analysis method of the present invention is one using a gas analysis device, the gas analysis device comprising a sample cell into which sample gas is introduced, a light source that irradiates the sample cell with light, and a photodetector that detects light intensity of light which passes through the sample cell irradiated by the light source, the gas analysis device analyzing a measurement target component contained in the sample gas based on a light intensity signal output from the photodetector, comprising outputting, comparably with a reference light intensity set in advance, a light intensity at calibration detected by the photodetector during calibration.

A program for a gas analysis device of the present invention is a program for a gas analysis device, the gas analysis device comprising a sample cell into which sample gas is introduced, a light source that irradiates the sample cell with light, and a photodetector that detects light intensity of light which passes through the sample cell irradiated by the light source, the gas analysis device analyzing a measurement target component contained in the sample gas based on a light intensity signal output from the photodetector, which causes a computer to perform the functions of, a concentration calculation unit which calculates a concentration of a measurement target component contained in the sample gas based on light intensity outputted from the photodetector; and a light intensity output unit which outputs, comparably with a reference light intensity set in advance, a light intensity at calibration detected by the photodetector during calibration.

Similar effects as those obtained by the gas analysis device described above can be achieved with the gas analysis method or the program for a gas analysis device configured like this.

### Effects of the Invention

According to this present invention configured like this, it is possible for a user to determine the mirror contamination status or the like in a gas analysis device that performs absorption analysis, thereby improving the reliability of measured values.

### BRIEF DESCRIPTION OF THE DRAWINGS

FIG. 1: Overall schematic diagram of a gas analysis device according to one embodiment of the present invention.

FIG. 2: Cross-sectional view schematically showing the configuration of a multiple reflection type cell in the same embodiment.

FIG. 3: Functional block diagram of an information processing device in the same embodiment.

FIG. 4: Example of a screen image output by a light intensity output unit of the same embodiment.

FIG. 5: Overall schematic diagram of an exhaust gas analysis system according to one embodiment of the present invention.

### MEANS FOR CARRYING OUT THE INVENTION

An embodiment of a gas analysis device 100 and an exhaust gas analysis system 200 equipped therewith according to the present invention is explained below with reference to the drawings.

### (1) Gas Analysis Device

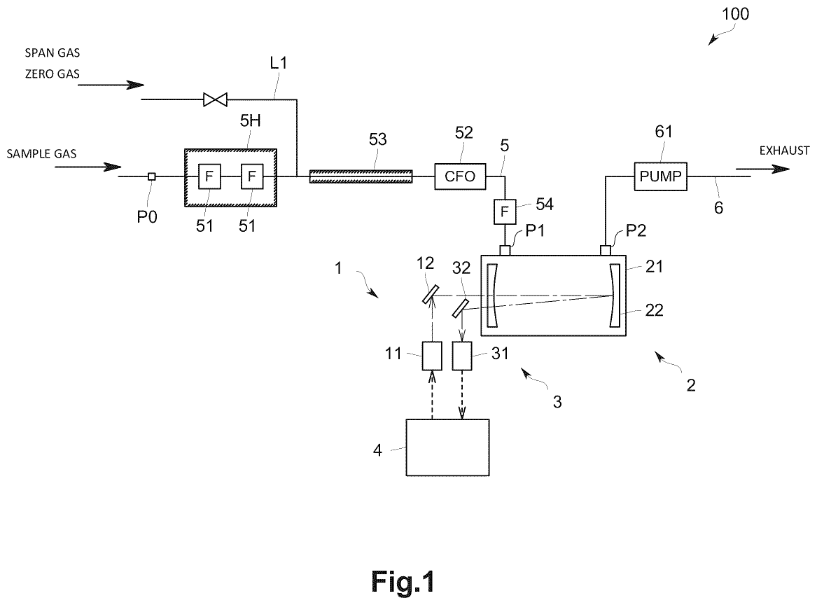

First, the gas analysis device 100 of the present embodiment will be described. The analysis device of the present embodiment is an exhaust gas analysis device 100 that measures the concentration of one or more components contained in exhaust gas emitted from an internal combustion engine of, for example, an automobile. Concretely, as shown in FIG. 1, the gas analysis device 100 is configured to collect, for example, some or all of the exhaust gas which exits from the tailpipe of an automobile by means of a sample collection unit P0, introduce the exhaust gas collected by said sample collection unit P0 (referred to also as ‘sample gas’ below) into a multiple reflection type sample cell 2, and measure the concentration of one or more measurement target components (for example, nitrogen compound components such as NO, NO₂, N₂O, or NH₃) in the exhaust gas using an absorption spectroscopy method.

More concretely, the gas analysis device 100 includes a light irradiation unit 1, a sample cell 2 into which sample gas is introduced and which causes light from the light irradiation unit 1 to undergo multiple reflections, a light detection unit 3 that detects light emitted from the sample cell 2, and an information processing device 4 that analyzes the measurement target component in the sample gas based on the light intensity signal detected by the light detection unit 3.

The light irradiation unit 1 includes one or more laser light sources 11 which emit laser light, and a guiding mechanism 12 consisting of a reflective mirror 22 or the like that guides the light from said laser light source 11 to the sample cell 2. The laser light source 11 is a wavelength tunable laser that emits laser light having an infrared region wavelength such as in the mid-infrared region or near-infrared region, or an oscillation wavelength in the ultraviolet region; for example, a semiconductor laser, such as a quantum cascade laser (QCL) or a wavelength tunable semiconductor laser, a solid-state laser, or a liquid laser may be used.

In particular, it is preferable that the laser light source 11 is a quantum cascade laser (QCL). In the absorption spectroscopy method making use of a QCL light source (a QCL-IR method), an element is used that is adjusted to oscillate light in a wave number range where the absorption peak of the target component exists.

The sample cell 2 is of a type called a Herriott cell. The sample cell 2 has a cell main body 21 into which a sample gas is introduced into an internal space, and a pair of reflective mirrors 22 provided in the cell main body 21 so as to face each other. The sample cell 2 is equipped with an introduction port P1 for introducing sample gas into the cell main body 21, and an outlet port P2 for leading out sample gas from inside the cell main body 21.

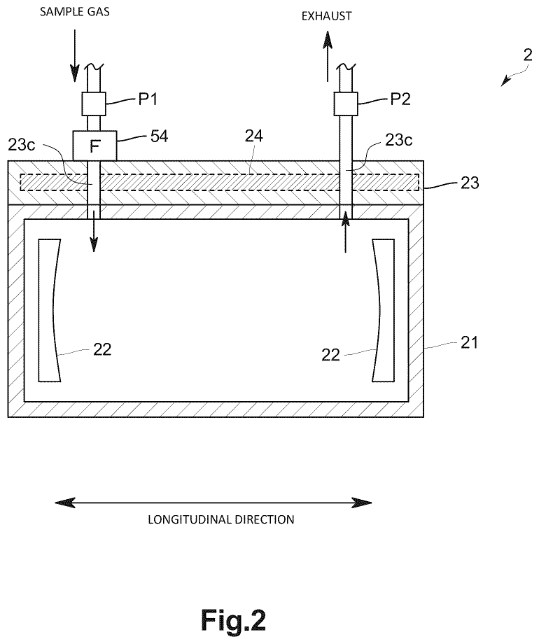

As shown in FIG. 2, the sample cell 2 includes a manifold member 23 equipped to the cell body 21 and a cell heating mechanism 24 that heats the cell body 21 and adjusts it to be a predetermined temperature (for example, 113° C. or 191° C. or able to be set in a range of 40° C. to 300° C.).

The manifold member 23, in addition to being provided with the above-mentioned introduction port P1 and outlet port P2, is block-shaped and has internal flow paths 23c (a gas introduction flow path, and a gas outlet flow path) which connect the introduction port P1 and the outlet port P2 to the internal space. The manifold member 23 is equipped to the outer surface of the cell main body 21 along its longitudinal direction, with its internal flow channel 23c connecting to vents penetrating a side wall of the cell main body 21.

The cell heating mechanism 24 includes a heater whose temperature can be regulated, and is equipped within a wall of or on an outer wall surface of the cell main body 21, or otherwise inside of or on an outer surface of the manifold member 23. Here, the cell heating mechanism 24 is embedded inside the manifold member 23.

The light detection unit 3 includes one or a plurality of photodetectors 31 which detect the intensity of light emitted from the interior of the sample cell 2 after multiple reflections. The photodetector 31 may be, for example, a thermal type, such as a relatively inexpensive thermopile, or a quantum type photoelectric element with good responsiveness such as HgCdTe. InGaAs, InAsSb, or PbSe. Moreover, a guiding mechanism 32 composed of a reflective mirror 22 for guiding light emitted from the sample cell 2 to the photodetector 31 is provided between the sample cell 2 and the photodetector 31. The light intensity signal obtained by the photodetector 31 is output to the information processing device 4.

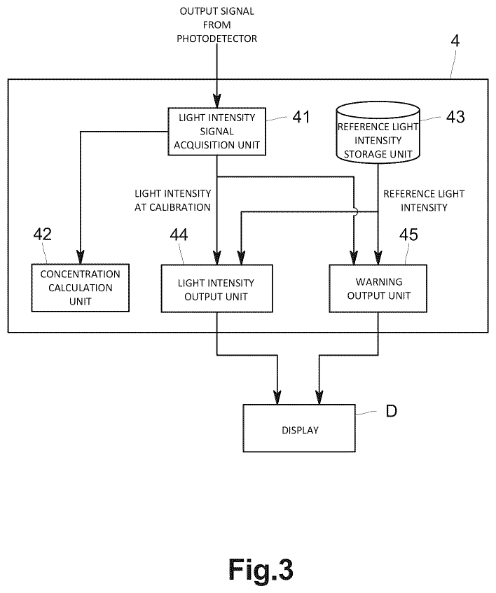

The information processing device 4 is equipped with an analog electric circuit consisting of a buffer, amplifier, etc.; a digital electric circuit consisting of a CPU, memory, etc.; and an AD converter. DA converter, etc., that mediate between the analog/digital electric circuits. The information processing device 4, by means of the CPU and its peripherals working together according to a predetermined program stored in a predetermined area of the memory, as shown in FIG. 3, performs at least the functions of a light intensity signal acquisition unit 41 that acquires a light intensity signal output from the light detector 31, and a concentration calculation unit 42 that calculates the concentration of each measurement target component by arithmetic processing of the acquired light intensity signal.

The gas analysis device 100 also includes a gas introduction line 5 which introduces the collected sample gas into the sample cell 2, and an exhaust line 6 which exhausts the analyzed sample gas. As for the gas introduction line 5, its upstream end is connected to the sample collection unit P0 and its downstream end is connected to the introduction port P1 of the sample cell 2. The upstream end of the exhaust line 6 is connected to the outlet port P2 of the sample cell 2.

The gas introduction line 5 is provided with, in order from upstream, one or a plurality of filters 51 (also called upstream side filters) for removing dust contained in the collected sample gas, and a flow restriction unit 52 for limiting the flow rate of the sample gas that has passed through said upstream side filters 51. The upstream side filters 51 are heated to a predetermined temperature (e.g., 113° C.) by a heating mechanism SH. Here, the flow restriction unit 52 is a critical flow orifice (CFO), the downstream side of which is reduced in pressure compared to the upstream side. Between the upstream side filters 51 and the flow restriction unit 52 in the gas introduction line 5, there is a heating pipe 53 to prevent adsorption and condensation of adsorptive gases in the sample gas, such as NH₃. The heating pipe 53 consists, for example, of a heater wound around a pipe. Also, connected to the gas introduction line 5 or the sample cell 2 is a calibration gas supply line L1 that supplies calibration gas (e.g., N₂), which is zero gas, span gas, etc., to sample cell 2 for calibration (zero calibration and span calibration) of the photodetector 31.

The exhaust line 6 is equipped with a pump 61 for introducing sample gas into the sample cell 2. The pump 61, along with creating a negative pressure in the sample cell 2, also creates negative pressure (e.g., about 25 kPa) in the flow path from the downstream side of the flow restriction unit 52 in the gas introduction line 5 to the sample cell 2.

The gas analysis device 100 of this embodiment is configured so that when calibration (specifically, zero calibration) is performed by the user, the light intensity at calibration, which is the light intensity detected by the photodetector 31 during said calibration, is output so as to be comparable with a reference light intensity set in advance. Specifically, as shown in FIG. 3, in the gas analysis device 100, the information processing device 4 further performs the functions of a reference light intensity storage unit 43, a light intensity output unit 44, and a warning output unit 45.

The reference light intensity storage unit 43 is set in a predetermined area of the memory, and stores reference light intensity data indicating reference light intensity which serves as a comparison reference for the light intensity detected during calibration. The reference light intensity indicates light intensity (specifically, the average value) detected by the photodetector 31 during zero calibration performed at the time of shipment of the product or before initiation of the first measurement. In other words, the reference light intensity indicates the light intensity detected by the photodetector 31 when zero calibration is performed in a state wherein the reflective mirrors 22 within the sample cell 2 are not contaminated by particulate matter or the like (or, wherein the contamination level is low). The reference light intensity storage unit 43 stores reference light intensity data showing reference light intensity in each wavelength region corresponding respectively to each of one or more measurement target components. If the gas analysis device 100 includes a plurality of photodetectors 31, reference light intensity data corresponding to each photodetector 31 is stored in the reference light intensity storage unit 43.

The light intensity output unit 44 outputs and displays the light intensity at calibration, which indicates the light intensity signal acquired by the light intensity signal acquisition unit 41 at the time of calibration (at the time of zero calibration), to a display D or the like, making it comparable to the reference light intensity which indicates the reference light intensity data stored in the reference light intensity storage unit 43.

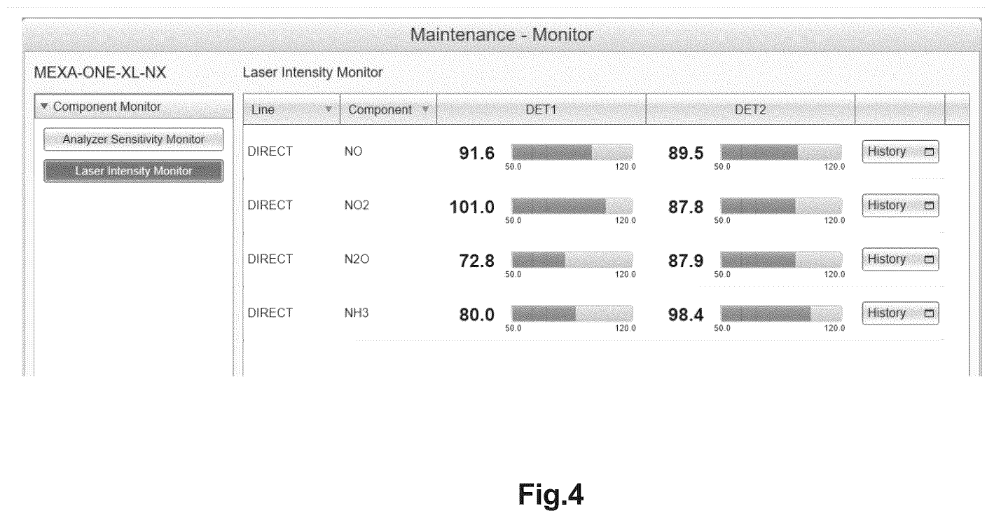

Specifically, as shown in FIG. 4, the light intensity output unit 44 outputs and displays, to the display D or the like, a light intensity comparison screen which shows a relative value (%) of the light intensity at calibration in regards to the reference light intensity, with the reference light intensity being 100%. Here, the light intensity output unit 44, along with displaying the relative value of the light intensity at calibration as a number, also displays said relative value as an indicator (icon). Moreover, if the gas analysis device 100 includes a plurality of photodetectors 31, the light intensity output unit 44 outputs and displays to the display D or the like the relative value of the light intensity at calibration corresponding to each of the photodetectors 31.

Each time zero calibration is performed by a user, the light intensity output unit 44 acquires the light intensity at calibration, calculates its relative value, and updates the relative value displayed on the display D to the latest one. Additionally, the light intensity output unit 44 may automatically record the relative value of the light intensity at calibration each time zero calibration is performed, and display the time series changes of the relative values as a graph.

The light intensity output unit 44 of this embodiment also calculates the relative value of light intensity at calibration in each wavelength region corresponding respectively to each of the plurality of measurement target components, and outputs and displays this to the display D. In this way, for example, if the light intensity at calibration of all of the outputs of the plurality of light sources 11 are markedly reduced at the same time, the user can determine that a component related to the common optical path thereof has failed; or, if, from among the light intensities at calibration output by the plurality of light sources 11, the light intensity at calibration of only a particular light source 11 is markedly reduced, the user can determine that a component of the optical path which includes the particular light source 11 has failed.

The warning output unit 45 compares the relative value of the light intensity at calibration with respect to the reference light intensity to a predetermined warning threshold value which can be set in advance, and if the relative value of the light intensity at calibration exceeds (or falls below) the threshold value, outputs a warning signal urging maintenance of the gas analysis device 100 to the display D or the like. Here, the warning threshold value is made to be 50%, but it may also be set at a plurality of levels, such as 65% and 50%. As for the content of the warning signal, it may indicate, for example, that maintenance should be performed right away, or that the time to perform maintenance is approaching, etc. Also, the warning signal may be one urging the maintenance of each component (specifically, the reflective mirror 22, the light source, etc.) included in the gas analysis device 100. For example, if the light intensity at calibration of all of the outputs of the plurality of light sources 11 are markedly reduced at the same time, the warning output unit 45 may output a warning signal indicating that a component related to the common optical path is suspected to have failed. If, on the other hand, from among the light intensities at calibration output by the plurality of light sources 11, the light intensity at calibration of a particular light source 11 is markedly reduced, the warning output unit 45 may output a warning signal urging maintenance of a component of the optical path which includes the particular light source 11.

As shown in FIG. 1, the gas analysis device 100 of the present embodiment may be further equipped with a filter 54 (also called a downstream side filter) in the gas introduction line 5 on a downstream side of the flow restriction unit 52 (between it and the sample cell 2), for removing particulate matter in the sample gas. The downstream side filter 54 is installed in the gas introduction line 5 in a position such that its temperature is higher than the dew point temperature of the sample gas, and lower than the heating temperature (for example, 113° C.) of the cell main body 21 by the cell heating mechanism 24. As shown in FIG. 2, the downstream side filter 54 is installed to a side of the manifold member 23 opposite to that of the cell main body 21 side, so as to be positioned in the gas introduction path.

According to the gas analyzer 100 of the present embodiment configured like this, the light intensity at calibration detected by the photodetector 31 at the time of calibration is output so that it can be compared with a reference light intensity set in advance. Because of this, when calibration of the analysis device is performed, the user verifies the light intensity at calibration by comparing it with the reference light intensity, so that they are able to know the mirror contamination status or the like, and the reliability of measured values can be improved.

Moreover, the light intensity at calibration is not output as a raw signal, but rather as a value relative to a reference light intensity, making it easier to determine the extent of mirror contamination and the extent of light source deterioration, etc.

Additionally, since a warning signal is output when the relative value of the light intensity at calibration falls below a threshold value, the user is able to notice when the time to perform maintenance is approaching, or the necessity of performing maintenance right away, which allows the prevention of problems such as the gas analyzer 100 suddenly becoming unusable.

Also, since certain wavelength components are absorbed by contaminant components which adhere to the reflective mirror 22, by outputting the light intensity at calibration for each wavelength region corresponding to each measurement target component, and by the user comparing the light intensity at calibration in each wavelength region, the light intensity output unit 44 allows the contamination status of the mirror to be known in greater detail. That is, in a case where measurement is carried out in a plurality of wavelength regions, if one attempts to determine the contamination status of the mirror 22 by outputting only the light intensity at calibration of a certain wavelength region, there is a danger that the contamination status or the like of the mirror 22 will not be correctly determined, because it is not possible to know the light intensity at calibration in other wavelength regions. However, in the present embodiment, by determining the contamination status of the mirror 22 by outputting the light intensity at calibration of respective wavelength regions, the contamination status or the like of the mirror 22 can be known in greater detail.

Furthermore, in the gas analysis device 100 of the present embodiment, if a downstream side filter 54 is provided in a reduced pressure section downstream of the flow restriction unit 52 in the gas introduction line 5, it is possible to promote the particle growth of microscopic particles and capture these particles; microscopic particles which could not be captured by the upstream side filters 51 of the flow restriction unit 52 are captured, and it is possible to prevent the introduction of solid and particulate matter into the interior of the sample cell 2.

Furthermore, the downstream side filter 54 is maintained at a temperature higher than the dew point temperature of the sample gas passing therethrough and at a temperature lower than the above-mentioned predetermined temperature. Therefore, by making the filter provided in the reduced pressure section in the gas introduction line 5 a cold spot with a lower temperature than the measurement cell, high boiling point hydrocarbons, which cause mirror contamination, can be adsorbed by the filter before reaching a stage where they would be adsorbed within the sample cell 2.

### (2) Exhaust Gas Analysis System

Next, an aspect of an exhaust gas analysis system 200 which uses the gas analysis device 100 of the present embodiment will be described.

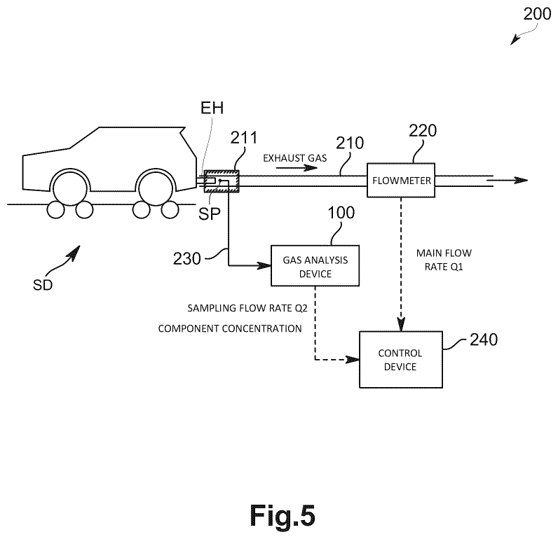

The exhaust gas analysis system 200 analyzes exhaust gas emitted from a test vehicle which is the test subject, and is for measuring the amount of emissions of a measurement target component contained in said exhaust gas. As shown in FIG. 5, the exhaust gas analysis system 200 includes a chassis dynamometer SD on which the test vehicle is placed; a main flow path 210, connected to the exhaust pipe EH of the test vehicle, into which is introduced the entirety of the exhaust gas (raw exhaust gas which has not been diluted) emitted from the engine; a flowmeter 220 which measures the flow rate of the exhaust gas which flows through the main flow path 210; a sampling part 230 which collects a portion of the exhaust gas from the main flow path 210; an above-mentioned gas analysis device 100 which analyzes the exhaust gas collected by the sampling part 230 and measures the concentration of the measurement target component; and a control device 240 which includes a function as an emissions amount calculation unit which calculates the amount of emissions of the measurement target component.

Here, if the amount of emissions of an adsorptive component such as NH₃ or the like are measured as the measurement target component, since the adsorptive component will adsorb to an inner pipe wall or the like which forms the flow path, analyzing the exhaust gas immediately after it has been emitted from the vehicle is preferable in order to improve the accuracy of measuring the concentration. Therefore, if the amount of emissions of adsorptive components or the like are being measured, it is preferable that concentration measurement be performed by sampling the exhaust gas from an upstream side of the flowmeter 220.

Therefore, the exhaust gas analysis system 200 of the present embodiment is configured such that the sampling part 230 is located in the main flow path 210 upstream of the flowmeter 220, so that a portion of the exhaust gas is collected immediately down from the exhaust pipe EH.

The flowmeter 220 of this embodiment measures the flow rate (also called main flow rate) of the exhaust gas flowing on a downstream side of a sampling point SP of the sampling part 230 in the main flow path 210. That is, the flow rate of the exhaust gas measured by the flowmeter 220 is a flow rate wherein the flow rate of the exhaust gas collected by the sampling part 230 has been subtracted from the total flow rate of exhaust gas introduced into the main flow path 210 from the exhaust pipe EH of the test vehicle. Specifically, the flowmeter 220 is an ultrasonic flowmeter, but it is not limited to this, and it may be of another type such as a pitot tube flowmeter.

The sampling part 230 is configured so as to collect exhaust gas from immediately down from (directly after the exit of) the exhaust pipe EH in the main flow path 210. The section between the exit of the exhaust pipe EH and the sampling point SP in the main flow path 210 is heated and temperature controlled by a heating mechanism 211 to prevent adsorption or condensation of adsorptive gases such as NH₃. The inner surface of the piping in the aforementioned temperature-controlled section of the main flow path 210 is polished to prevent adsorption of adsorptive gas.

In the exhaust gas analysis system 200, the emissions amount calculation unit is configured to calculate the amount of emissions of the measurement target component based on a corrected flow rate—the main flow rate measured by the flow meter 220 corrected by the sampling flow rate, which is the flow rate collected by the sampling part 230—and the concentration of the measurement target component measured by the gas analysis device 100. Specifically, the emissions amount calculation unit obtains the main flow rate (Q1) measured by the flowmeter 220 on the main flow path 210 and the sampling flow rate (Q2) measured by a flowmeter (not shown) included in the gas analysis device 100, and these are summed to calculate the corrected flow rate (Q3). Then, by multiplying the concentration of the component to be measured obtained from the gas analyzer 100 by the corrected flow rate, the emitted mass of the measurement target component is calculated. Note that as the sampling flow rate (Q2), it is also possible to use a suction flow rate or the like set in advance in the gas analysis device 100.

According to the exhaust gas analysis system 200 of the present embodiment configured as such, because the exhaust gas is sampled immediately after being emitted from the exhaust pipe EH on an upstream side of the flowmeter 220, highly accurate measurement of the concentration of measurement target components with high adsorptivity is possible in a state wherein adsorption to the inner pipe wall is minimal. Also, because the flow rate measured by the flowmeter 220 is corrected by the flow rate of the sampled exhaust gas, even when sampling of the exhaust gas is performed from the upstream of the flowmeter 220, the influence of this on the flow rate value used for calculation of the amount of emissions can be minimized. Thanks to this, the influence of adsorption of measurement target components onto the inner pipe wall is reduced, and the amount of emissions thereof can be measured with high accuracy.

Note also that the gas analysis device 100 and the exhaust gas analysis system 200 of the present invention are not limited to the above-described embodiments.

For example, the gas analysis device 100 of another embodiment may be one in which no filter is provided on the downstream side filter of the flow restriction unit 52 in the gas introduction line 5. Also, as for the sample cell 2, it is possible to not include the manifold member 23 and the cell heating mechanism 24 and the like.

Furthermore, rather than being limited to doing so when zero calibration is carried out, the gas analyzer 100 of the above embodiment may be configured to, when span calibration is carried out, output the light intensity at calibration, which is the light intensity detected by the photodetector 31 at the time of calibration, to be comparable to a reference light intensity set in advance. In this case, the reference light intensity product indicates light intensity detected by the photodetector 31 during span calibration performed at the time of shipment or prior to the start of the first measurement.

Also, the light intensity output unit 44 of the embodiment described above calculates a relative value of the light intensity at calibration in each wavelength region corresponding respectively to the plurality of measurement target components, and outputs this to a display D, but it is not limited to this. The light intensity output unit 44 of another embodiment may output the relative value of light intensity at calibration corresponding to a wavelength region of only some components of the plurality of measurement target components. Moreover, the light intensity output unit 44 may output and display both an absolute value of the light intensity at calibration and an absolute value of the reference light intensity to the display D. Also, the light intensity output unit 44 may, rather than outputting and displaying the detected light intensity at calibration to the display D, output it to a user via paper or voice.

The light intensity output unit 44 of the above-described embodiment shows the relative value of the light intensity at calibration as a number, as well as showing said relative value as an indicator (icon), but it may instead display only one of these.

Also, the information processing device 4 of another embodiment may be one which includes at least a light intensity output unit 44, and need not include functionality as a warning output unit 45.

The gas analysis device 100 of the above-described embodiment can be applied in gas analysis devices 100 that use the principle of absorption analysis, such as the FTIR method, the QCL-IR method, and the NDIR method. The sample cell 2 need not be a multiple reflection type cell. Furthermore, the sample cell 2 may be, for example, a White cell, rather than a Herriott cell.

In the above-described embodiment, the light irradiation unit 1 includes a laser light source 11 as its light source, but it is not limited to this. In another embodiment, the light irradiation unit 1 may include a light emitting diode (LED), a halogen lamp, etc., as a light source.

As measurement target components, the gas analysis device 100 of another embodiment may be configured to measure, in addition to what is described above, the concentration of hydrocarbons such as CH₄, sulfur compounds such as SO₂, CO, CO₂, or H₂O.

In the embodiment described above, the exhaust gas analysis system 200 measures measurement target components within exhaust gas emitted in a test using a chassis dynamometer, but it is not limited to this. In another embodiment, it may measure measurement target components in exhaust gas emitted in a test using an engine test device, or a drive test device for a power train or the like. Also, the exhaust gas analysis system 200 may be an on-vehicle type one which is equipped to the test vehicle.

In the embodiment described above, the gas analysis device 100 and the exhaust gas analysis system 200 analyze measurement target components contained in exhaust gas emitted from the internal combustion engine or the like, but they are not limited to this. In another embodiment, for example, they may measure measurement target components contained in flue gas emitted from an external combustion engine of a thermal power station or the like, or from factory. The gas analysis device 100, not being limited to exhaust gas, may be used to analyze other gases; for example, it may be used for the analysis of gases emitted from rechargeable batteries, such as storage batteries, or from fuel cells or the like.

Needless to say, the present invention is not limited to the aforementioned embodiments, and various other variations are possible without departing from the intent of the invention.

### INDUSTRIAL APPLICABILITY

According to the present invention described above, in a gas analysis device that performs absorption analysis, it is possible for a user to determine the mirror contamination status or the like, and to improve the reliability of measured values thereof.

### EXPLANATION OF REFERENCE SIGNS

100 gas analysis device
1 light irradiation unit
2 sample cell
3 light detection unit
44 light intensity output unit

1. A gas analysis device comprising:
a sample cell into which sample gas is introduced;
a light source that irradiates the sample cell with light;
a photodetector that detects light intensity of light which passes through the sample cell irradiated by the light source;
a concentration calculation unit which calculates a concentration of a measurement target component contained in the sample gas based on light intensity outputted from the photodetector; and
a light intensity output unit that outputs, comparably with a reference light intensity set in advance, a light intensity at calibration detected by the photodetector during calibration.

2. The gas analysis device according to claim 1, further comprising
a calibration gas supply line that supplies a calibration gas to the sample cell, wherein
the light intensity output unit outputs, as the light intensity at calibration, light intensity detected by the photodetector in a state in which the calibration gas is supplied to the sample cell.

3. The gas analysis device according to claim 1, wherein
the light intensity output unit outputs the light intensity at calibration as a relative value with respect to the reference light intensity.

4. The gas analysis device according to claim 3, further comprising
a warning output unit which compares the relative value with a predetermined threshold value set in advance, and outputs a warning signal if the relative value exceeds the threshold value.

5. The gas analysis device according to claim 1, wherein
the gas analysis device analyzes a plurality of measurement target components contained in the sample gas; and
the light intensity output unit outputs the light intensity at calibration for each wavelength region corresponding to each of the measurement target components.

6. The gas analysis device according to claim 1, wherein
the reference light intensity is light intensity detected by the photodetector during calibration performed at a time of product shipment or before initiation of a first measurement.

7. The gas analysis device according to claim 1, wherein
the light intensity output unit outputs, as the light intensity at calibration, light intensity detected by the photodetector during zero calibration.

8. The gas analysis device according to claim 1, wherein
the sample cell is a multiple reflection type cell that emits incident light to an exterior after multiple reflections.

9. The gas analysis device according to claim 1, wherein
the gas analysis device is an FTIR method or a QCL-IR method type on.

10. The gas analysis device according to claim 1, further comprising
a cell heating mechanism which heats the sample cell to a predetermined temperature, and
a gas introduction line which introduces the collected sample gas into the sample cell, and is provided with a flow restriction unit which restricts a flow rate of the sample gas introduced into the sample cell, wherein
a filter is provided in the gas introduction line on a downstream side of the flow restriction unit, for eliminating particulate matter contained within the sample gas.

11. The gas analysis device according to claim 10, wherein
the filter is maintained at a temperature higher than a dew point temperature of the sample gas passing therethrough, and lower than the predetermined temperature.

12. The gas analysis device according to claim 10, wherein
an upstream side filter is further provided in the gas introduction line on an upstream side of the flow restriction unit, for eliminating particulate matter from within the sample gas.

13. An exhaust gas analysis system that analyzes a measurement target component contained in exhaust gas emitted from a test subject which is a vehicle or a part thereof, comprising:
a main flow path connected to an exhaust pipe of the test subject, into which the exhaust gas is introduced;
a flowmeter which measures a flow rate of the exhaust gas flowing in the main flow path;
a sampling part which collects a portion of the exhaust gas from the main flow path upstream of the flowmeter;
the gas analysis device according to claim 1 that analyzes the exhaust gas collected by the sampling part and measures a concentration of the measurement target component; and
an emissions amount calculation unit which calculates an amount of emissions of the measurement target component based on a corrected flow rate, which is a flow rate measured by the flowmeter which has been corrected by a flow rate collected by the sampling part, and a concentration of the measurement target component measured by the gas analysis device.

14. The exhaust gas analysis system according to claim 13, wherein
the measurement target component has high adsorptivity to an inner pipe wall which forms the main flow path, and includes a water-soluble component.

15. The exhaust gas analysis system according to claim 13, wherein
the measurement target component includes NH₃.

16. The exhaust gas analysis system according to claim 13, further comprising
a heating mechanism which heats a section of the main flow path between an exit of the exhaust pipe and a sample point of the sampling part.

17. The exhaust gas analysis system according to claim 13, wherein
the exhaust gas flowing in the main flow path is raw exhaust gas which has not been diluted.

18. A gas analysis method using a gas analysis device, the gas analysis device comprising a sample cell into which sample gas is introduced, a light source that irradiates the sample cell with light, and a photodetector that detects light intensity of light which passes through the sample cell irradiated by the light source, the gas analysis device analyzing a measurement target component contained in the sample gas based on a light intensity signal output from the photodetector, comprising
outputting, comparably with a reference light intensity set in advance, a light intensity at calibration detected by the photodetector during calibration.

19. A non-transitory computer readable medium having a program for a gas analysis device stored thereon, the gas analysis device comprising a sample cell into which sample gas is introduced, a light source that irradiates the sample cell with light, and a photodetector that detects light intensity of light which passes through the sample cell irradiated by the light source, the gas analysis device analyzing a measurement target component contained in the sample gas based on a light intensity signal output from the photodetector, the program, when executed by a computer, causing the computer to perform the functions of:
a concentration calculation unit which calculates a concentration of a measurement target component contained in the sample gas based on light intensity outputted from the photodetector; and
a light intensity output unit which outputs, comparably with a reference light intensity set in advance, a light intensity at calibration detected by the photodetector during calibration.
